(19) United States
(12) Patent Application Publication
(10) Pub. No.: US 2019/0180180 A1
(43) Pub. Date: Jun. 13, 2019

(54) INFORMATION PROCESSING SYSTEM, INFORMATION PROCESSING METHOD, AND RECORDING MEDIUM

(71) Applicant: NEC Corporation, Tokyo (JP)

(72) Inventor: Hiroshi TAMANO, Tokyo (JP)

(73) Assignee: NEC Corporation, Tokyo (JP)

(21) Appl. No.: 16/310,851

(22) PCT Filed: Jun. 30, 2016
(86) PCT No.: PCT/JP2016/003137

§ 371 Date: Dec. 18, 2018

(51) Int. Cl. G06N 3/08; G06N 20/20; G06N 7/00

(52) U.S. Cl. CPC G06N 3/08; G06N 7/00; G06N 20/20

(57) ABSTRACT

An information processing system for adjusting a parameter related to an analysis pipeline for various validation methods is provided. An analysis pipeline adjustment system includes an initialization unit (110) and an adjustment unit (150). The initialization unit (110) receives an input of a validation module that generates an analysis pipeline model and calculates an evaluation value by using an input analysis pipeline in accordance with a predetermined validation method, and outputs the generated analysis pipeline model and the calculated evaluation value. The adjustment unit (150) searches for, within a search range of a parameter set and in accordance with a predetermined search method, a value of the parameter set for which the evaluation value is optimized by inputting to the validation module the analysis pipeline to which a value of the pipeline parameter is applied and executing the validation module.

### TECHNICAL FIELD

The present invention relates to an information processing system, an information processing method, and a program, and more particularly, to an information processing system, an information processing method, and a recording medium that generate an analysis pipeline.

### BACKGROUND ART

A procedure of data analyzing in machine learning and data mining broadly includes a pre-process on data to be analyzed and learning process performed by inputting the pre-processed data to an analysis engine. In the pre-process, removal of an abnormal value and a deficit value in data, scale conversion such as standardization and normalization, generation of a necessary attribute, and the like are performed. In the engine, a regression analysis, a discriminant analysis, clustering, and the like are performed as learning process depending on a purpose.

The series of processes of data analyzing can be expressed by, for example, a series of processes including removal of a deficit value, standardization, and a regression analysis, namely, a pipeline. Hereinafter, the series of processes of data analyzing is referred to as an analysis pipeline.

Some processes in the analysis pipeline include a parameter that can be adjusted by a person. For example, in an abnormal value removing process, a value to be regarded as abnormal is set as a parameter. Further, in a discriminant analysis process, when a decision tree is used in a discriminant analysis, the tallest height of a tree to be learned is set as a parameter. Hereinafter, a parameter related to a pre-process and a learning process of the analysis pipeline is also referred to as a pipeline parameter.

Setting an appropriate value to a pipeline parameter is important for improving precision of an analysis. For example, when a height of a decision tree is too high, a model generated by learning overfits data, whereas, when a height of a decision tree is too low, a model generated by learning underfits data. Therefore, a parameter needs to be adjusted in such a way that an appropriate value is set to data to be analyzed.

Such adjustment of a pipeline parameter by a person generally takes time. Thus, a system for searching for an appropriate value of a parameter and adjusting the value is used. Grid Search is known as the simplest and general method among methods of searching for a value of a parameter. In Grid Search, a grid is generated based on candidate values of each parameter, all grid points are searched, and a set of optimum values of parameters is obtained. For example, when two parameters a and b respectively have candidate values like a=[1, 10, 100] and b=[1, 0.1, 0.01], nine combinations (3×3 combinations) of values are searched. Although Grid Search is simple, grid points to be searched are likely to be massive, and thus taking time. As a method for solving such a problem of Grid Search, Random Search, a method to which Bayesian optimization is applied, and the like are proposed.

Further, in adjustment of a pipeline parameter, validation of a generated model needs to be performed together with a search for a value of a parameter. As a general validation method of machine learning, a method that divides data to be analyzed into two pieces of data of learning data and test data, generates a model with the learning data, and calculates an evaluation value with the test data is known. In this method, a prediction is performed based on test data by using a generated model, and precision of the prediction is calculated as an evaluation value of the model. Hereinafter, this method is referred to as Single Validation. Furthermore, Cross Validation that repeats generation of a similar model and calculation of an evaluation value while changing pieces of data used as learning data and test data among the same pieces of data to be analyzed is also known.

Systems for adjusting a parameter by using the search method and the validation method are described in the following literatures. For example, NPL 1 describes GridSearchCV using Grid Search and Cross Validation, and RandomSearchCV using Random Search and Cross Validation, as a search method and a validation method, respectively. NPL 2 describes Cross Validator using Grid Search and Cross Validation as a search method and a validation method, respectively.

Further, NPL 3 describes Random Search described above as a search method. NPL 4 describes a method to which Bayesian optimization is applied as a search method.

### CITATION LIST

### Non Patent Literature

[NPL 1] “scikit-learn: machine learning in Python”, [online], [Retrieved on May 26, 2016], Internet <URL: http://scikit-learn.org/stable/>

[NPL 2] “Overview: estimators, transformers and pipelines—spark.ml”, [online], [Retrieved on May 26, 2016], Internet <URL: http://spark.apache.org/docs/latest/ml-guide.html>

[NPL 3] James Bergstra, Yoshua Bengio, “Random Search for Hyper-Parameter Optimization”, Journal of Machine Learning Research 13, pages 281-305, 2012

[NPL 4] Jasper Snoek, Hugo Larochelle, Ryan P. Adams, “Practical Bayesian Optimization of Machine Learning Algorithms”, Advances in Neural Information Processing Systems 25 (NIPS 2012), 2012

### SUMMARY OF INVENTION

### Technical Problem

However, GridSearchCV and RandomSearchCV described in NPL 1 and CrossValidator described in NPL2 have the following problem. That is, since each of these systems has a fixed search method and a fixed validation method, when, for example, a pipeline parameter is adjusted by various validation methods, different systems need to be used according to each validation method. In analysis business, not only Single Validation and Cross Validation described above, but also an original validation method suitable for more actual usage scenes is used as a validation method. For example, in prediction of time-series data, a method of performing a prediction for a year by using a relearned model every three months and obtaining yearly average precision of the model, and the like are used as a validation method. Therefore, preparing a system for adjusting a parameter for each validation method is unrealistic.

An example object of the present invention is to provide an information processing system, an information processing method, and a recording medium that are capable of solving the above-described problem and adjusting a parameter related to an analysis pipeline for various validation methods.

### Solution to Problem

An information processing system for generating an analysis pipeline model by using an analysis pipeline, the analysis pipeline including a pre-process and a learning process for data to be analyzed, a value of a pipeline parameter being a parameter related to at least one of the pre-process and the learning process being applied to the analysis pipeline, the analysis pipeline model including the pre-process and a learned model being learned with the learning process, according to an exemplary aspect of the present invention includes: initialization means for receiving an input of a validation module that generates the analysis pipeline model and calculates an evaluation value of the generated analysis pipeline model by using an input analysis pipeline in accordance with a predetermined validation method, and outputs the generated analysis pipeline model and the calculated evaluation value; and adjustment means for searching for, within a search range of a parameter set including the pipeline parameter and in accordance with a predetermined search method, a value of the parameter set for which the evaluation value is optimized by inputting to the validation module the analysis pipeline to which a value of the pipeline parameter is applied and executing the validation module, and outputting the analysis pipeline model for which the evaluation value is optimized.

An information processing method for generating an analysis pipeline model by using an analysis pipeline, the analysis pipeline including a pre-process and a learning process for data to be analyzed, a value of a pipeline parameter being a parameter related to at least one of the pre-process and the learning process being applied to the analysis pipeline, the analysis pipeline model including the pre-process and a learned model being learned with the learning process, according to an exemplary aspect of the present invention includes: receiving an input of a validation module that generates the analysis pipeline model and calculates an evaluation value of the generated analysis pipeline model by using an input analysis pipeline in accordance with a predetermined validation method, and outputs the generated analysis pipeline model and the calculated evaluation value; and searching for, within a search range of a parameter set including the pipeline parameter and in accordance with a predetermined search method, a value of the parameter set for which the evaluation value is optimized by inputting to the validation module the analysis pipeline to which a value of the pipeline parameter is applied and executing the validation module, and outputting the analysis pipeline model for which the evaluation value is optimized.

A computer readable storage medium recording thereon a program for generating an analysis pipeline model by using an analysis pipeline, the analysis pipeline including a pre-process and a learning process for data to be analyzed, a value of a pipeline parameter being a parameter related to at least one of the pre-process and the learning process being applied to the analysis pipeline, the analysis pipeline model including the pre-process and a learned model being learned with the learning process, the program, according to an exemplary aspect of the present invention causes a computer to perform processes including: receiving an input of a validation module that generates the analysis pipeline model and calculates an evaluation value of the generated analysis pipeline model by using an input analysis pipeline in accordance with a predetermined validation method, and outputs the generated analysis pipeline model and the calculated evaluation value; and searching for, within a search range of a parameter set including the pipeline parameter and in accordance with a predetermined search method, a value of the parameter set for which the evaluation value is optimized by inputting to the validation module the analysis pipeline to which a value of the pipeline parameter is applied and executing the validation module, and outputting the analysis pipeline model for which the evaluation value is optimized.

### Advantageous Effects of Invention

An advantageous effect of the present invention is to enable adjusting a parameter related to an analysis pipeline for various validation methods.

### BRIEF DESCRIPTION OF DRAWINGS

FIG. 1 is a block diagram illustrating a characteristic configuration of a first example embodiment of the present invention.

FIG. 2 is a block diagram illustrating a configuration of an analysis pipeline adjustment system 100 in the first example embodiment of the present invention.

FIG. 3 is a block diagram illustrating a configuration of the analysis pipeline adjustment system 100 realized by a computer in the first example embodiment of the present invention.

FIG. 4 is a diagram illustrating an example of an analysis pipeline in the first example embodiment of the present invention.

FIG. 5 is a diagram illustrating an example of input and output data in each block of the analysis pipeline in the first example embodiment of the present invention.

FIG. 6 is a diagram illustrating an example of an analysis pipeline model in the first example embodiment of the present invention.

FIG. 7 is a diagram illustrating an example of output data of the analysis pipeline model in the first example embodiment of the present invention.

FIG. 8 is a flowchart illustrating operation of the analysis pipeline adjustment system 100 in the first example embodiment of the present invention.

FIG. 9 is a flowchart illustrating a process of an objective function in the first example embodiment of the present invention.

FIG. 10 is a diagram illustrating an example of a search range in the first example embodiment of the present invention.

FIG. 11 is a diagram illustrating another example of a search range in the first example embodiment of the present invention.

FIG. 12 is a flowchart illustrating another process of an objective function in the first example embodiment of the present invention.

FIG. 13 is a diagram illustrating another example of a search range in the first example embodiment of the present invention.

FIG. 14 is a diagram illustrating another example of a search range in the first example embodiment of the present invention.

FIG. 15 is a diagram illustrating an example of an analysis pipeline in a second example embodiment of the present invention.

FIG. 16 is a flowchart illustrating operation of the analysis pipeline adjustment system 100 in the second example embodiment of the present invention.

FIG. 17 is a flowchart illustrating a process of an objective function in the second example embodiment of the present invention.

FIG. 18 is a diagram illustrating an example of a search range in the second example embodiment of the present invention.

### EXAMPLE EMBODIMENT

Example embodiments of the present invention is described in detail with reference to drawings. Note that, similar structural components have the same reference signs in each of the drawings and each of the example embodiments in the specification, and description thereof is appropriately omitted.

### First Example Embodiment

A first example embodiment of the present invention is described.

First, an analysis pipeline and an analysis pipeline model in the example embodiment of the present invention are described.

FIG. 4 is a diagram illustrating an example of an analysis pipeline in the first example embodiment of the present invention. The analysis pipeline includes a block for performing a pre-process on data and a block for performing a learning process by using the pre-processed data. In the pre-process, removal of an abnormal value and a deficit value, scale conversion, generation of an attribute, and the like are performed. In the learning process, generation of a model (learned model) for performing a prediction or classification, such as a regression equation and a decision tree, is performed. The generation of the model includes calculation of a model parameter such as a coefficient in the regression equation, a structure of the decision tree, and a determination condition. An analysis pipeline “Pipeline1” in FIG. 4 is an analysis pipeline that generates an analysis pipeline model that predicts low density lipoprotein (LDL) cholesterol from human height and weight. Herein, in the analysis pipeline “Pipeline1”, as blocks for performing the pre-process on data, a block “BMI” for calculating a body mass index (BMI) and a block “Pow (WEIGHT)” for calculating a d-th power of weight are set. Further, as a block for performing the learning process, a block “RIDGE REGRESSION (LDL)” for generating a ridge regression model that predicts LDL cholesterol from the pre-processed data by using a regularization parameter λ is set.

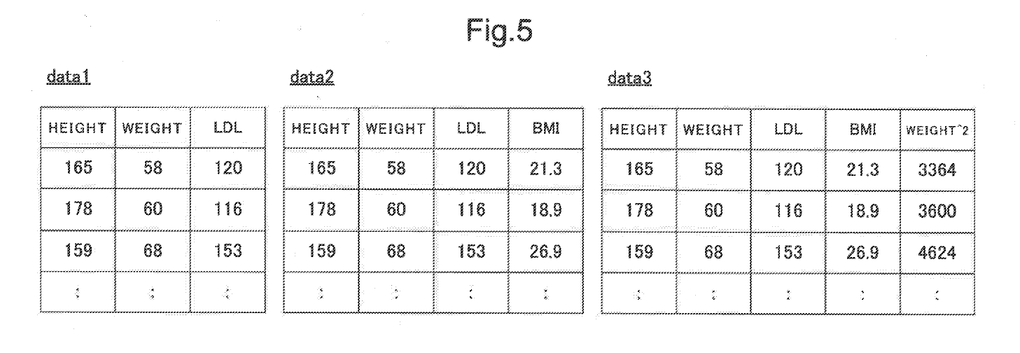

FIG. 5 is a diagram illustrating an example of input and output data in each block of the analysis pipeline in the first example embodiment of the present invention. For example, when data “data1” in FIG. 5 is input to the analysis pipeline in FIG. 4, the data “data1” is input to the block “BMI” and data such as “data2” is output. Furthermore, the data “data2” is input to the block “Pow (WEIGHT)”, and data such as “data3” is output. Then, the data “data3” is input to the block “RIDGE REGRESSION (LDL)”, and the learned model “RIDGE REGRESSION MODEL (LDL)” for predicting LDL cholesterol is generated.

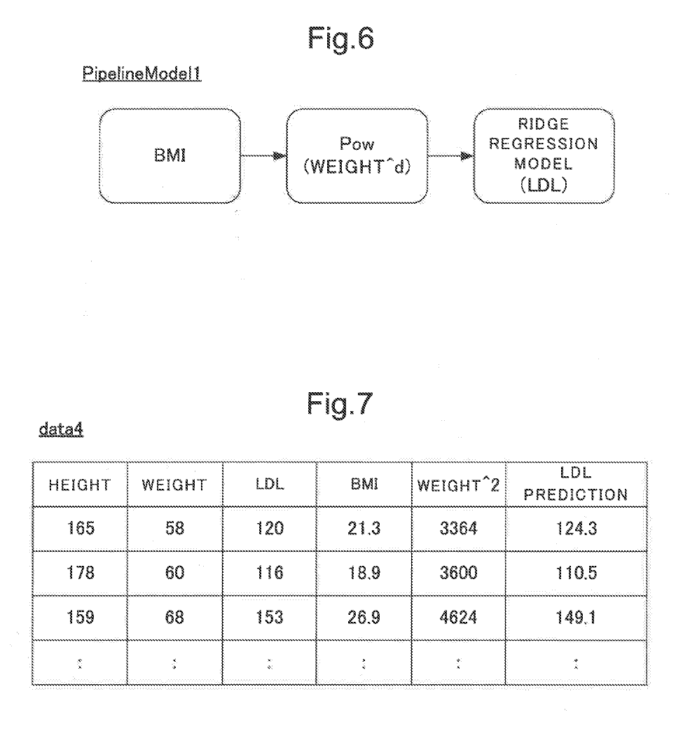

FIG. 6 is a diagram illustrating an example of an analysis pipeline model in the first example embodiment of the present invention. The analysis pipeline model includes a block for performing a pre-process on data similarly to the analysis pipeline, and a block for performing a process of the learned model generated by the analysis pipeline. In the learned model, a prediction or classification is performed by using the pre-processed data. An analysis pipeline model “PipelineModel1” in FIG. 6 is an analysis pipeline model generated by the analysis pipeline “Pipeline1” in FIG. 4. In the analysis pipeline model “PipelineModel1”, as blocks for performing the pre-process on data, a block “BMI” for calculating a BMI and a block “Pow (WEIGHT̂d)” for calculating a d-th power of weight are set. Further, as a block for performing process on a learned model, a block “RIDGE REGRESSION MODEL (LDL)” is set.

FIG. 7 is a diagram illustrating an example of output data of the analysis pipeline model in the first example embodiment of the present invention. For example, when the data “data1” in FIG. 5 is input to the analysis pipeline model in FIG. 6, the pre-processed data “data3” is input to the block “RIDGE REGRESSION MODEL (LDL)”. Then, data to which a column of predicted values of LDL cholesterol is added, such as data “data4” in FIG. 7, is output.

The analysis pipeline has a pipeline parameter related to at least one of the pre-process and the learning process. In the analysis pipeline in FIG. 4, a degree d for the block “Pow (WEIGHT)” of the pre-process and a value of a regularization parameter λ for the block “RIDGE REGRESSION (LDL)” of the learning process are set as values of the pipeline parameters.

Note that, the analysis pipeline and the analysis pipeline model are programs executed on a central processing unit (CPU), for example.

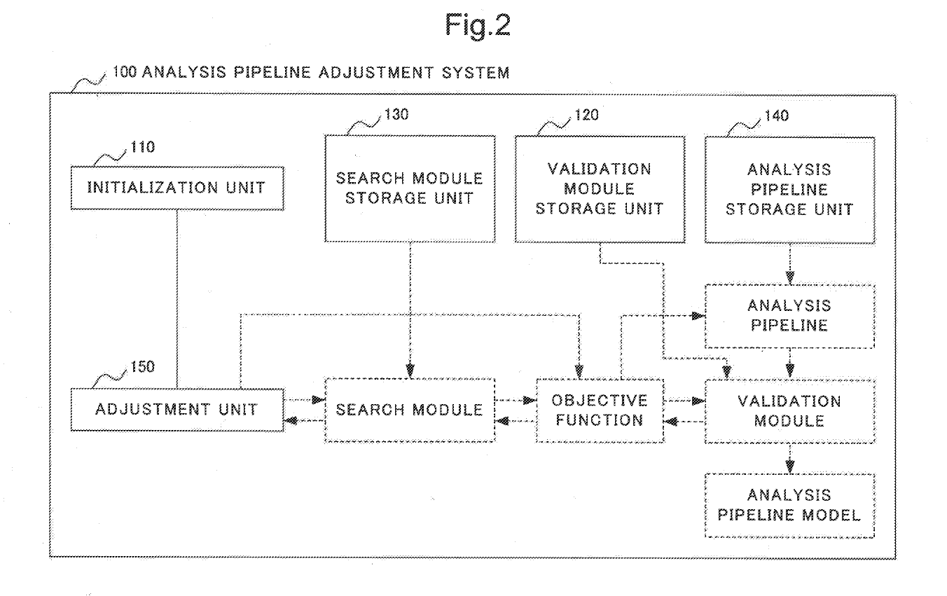

Next, a configuration of the first example embodiment of the present invention is described. FIG. 2 is a block diagram illustrating a configuration of an analysis pipeline adjustment system 100 in the first example embodiment of the present invention. The analysis pipeline adjustment system 100 is one example embodiment of an information processing system according to the present invention.

With reference to FIG. 2, the analysis pipeline adjustment system 100 includes an initialization unit 110, a validation module storage unit 120, a search module storage unit 130, an analysis pipeline storage unit 140, and an adjustment unit 150.

The initialization unit 110 receives, from a user and the like, inputs of data to be analyzed, and an analysis pipeline, a validation module, and a search module to be used in an analysis. The validation module, the search module, and the analysis pipeline are programs executed on the CPU, for example. Note that, the initialization unit 110 may receive inputs of identifiers of the analysis pipeline and the modules to be used among a plurality of analysis pipelines and modules stored in a storage unit (not illustrated) and the like.

As illustrated in FIG. 2, the search module is executed by the adjustment unit 150, and the validation module is executed by the search module via an objective function. Inputs, outputs, and a process of the validation module, the objective function, and the search module are defined as follows.

### <Validation Module>

As inputs to the validation module, data to be analyzed and an analysis pipeline to which a value of one or more pipeline parameters are set (applied) are input from the objective function.

The validation module generates an analysis pipeline model and calculates an evaluation value of the generated analysis pipeline model by using the input data and the input analysis pipeline in accordance with a predetermined validation method corresponding to the validation module.

The validation module returns (outputs) the generated analysis pipeline model and the calculated evaluation value to the objective function.

Herein, as the predetermined validation method, Single Validation and Cross Validation described above, and the like are used, for example. Further, as the evaluation value, a root mean squared error (RMSE) calculated from a value predicted by the generated analysis pipeline model and an actual value, and the like are used, for example.

### <Objective Function>

As inputs to the objective function, an argument x is specified (input) from the search module. As the argument x, for a set of one or more parameters (hereinafter also referred to as a parameter set), values of the parameters (hereinafter also described as values of a parameter set) are set. The parameter set includes one or more above-described pipeline parameters.

FIG. 9 is a flowchart illustrating a process of the objective function in the first example embodiment of the present invention. The objective function sets (applies) a value of a pipeline parameter included in a parameter set specified as an argument x to an analysis pipeline to be used (Step S210). The objective function inputs data to be analyzed and the analysis pipeline to which the value of the pipeline parameter is set (applied) to a validation module to be used, and executes the validation module (Step S220).

The objective function returns (outputs) an evaluation value and an analysis pipeline model obtained as a result of the execution of the validation module as a return value to the search module (Step S230).

### <Search Module>

As inputs to the search module, an objective function is input from the adjustment unit 150. Further, a search range for the argument x (the values of the parameter set) of the objective function is set by the initialization unit 110. As the search range, a range for values in accordance with a searching method of the search module to be used, the analysis pipeline to be used, and the validation module to be used is set. Note that, the search range may be input from the adjustment unit 150 instead of the initialization unit 110. Further, the search range may be set in the search module input from a user and the like, in advance.

The search module specifies a value within the search range as the argument x, and executes the input objective function. The search module searches for the argument x (the values of the parameter set) for which an evaluation value included in a return value of the objective function is optimized (takes minimum or maximum), in accordance with a predetermined search method of the search module. The search module returns (outputs) the return value (the evaluation value and the analysis pipeline model) of the objective function when the evaluation value is optimized, to the adjustment unit 150.

Herein, as the predetermined search method, Grid Search and Random Search described above, and the like are used, for example. Further, as long as the search module can execute the objective function, an input of the objective function may be omitted. Further, the search module may also return (output) the argument x (the values of the parameter set) when the evaluation value is optimized together with the return value from the objective function, to the adjustment unit 150.

By such definitions of the validation module, the objective function, and the search module, the validation module can be realized without depending on the search module. Further, the search module can also be realized without depending on the analysis pipeline and the validation module to be used.

The validation module storage unit 120 stores a validation module to be used.

The search module storage unit 130 stores a search module to be used.

The analysis pipeline storage unit 140 stores an analysis pipeline to be used.

The adjustment unit 150 generates the above-described objective function in accordance with data to be analyzed, an analysis pipeline, and a validation module to be used. The adjustment unit 150 inputs the generated objective function to a search module to be used, and executes the search module. The adjustment unit 150 outputs an analysis pipeline model obtained as a result of the execution of the search module to a user and the like.

Note that, the analysis pipeline adjustment system 100 may be a computer including a CPU and a storage medium that stores a program and operating by control based on the program.

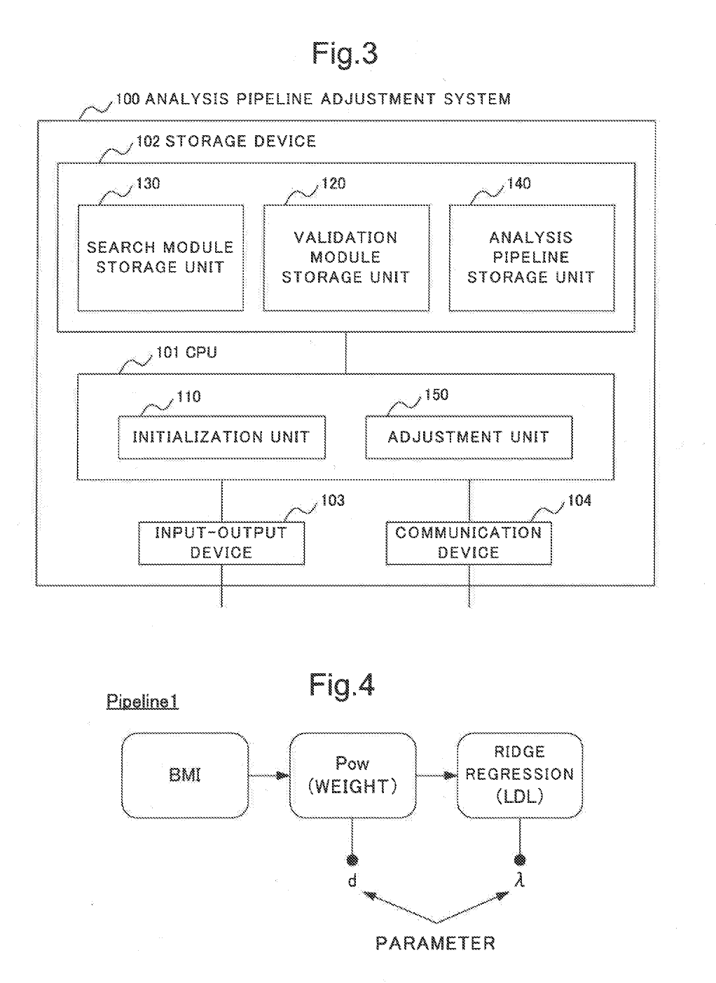

FIG. 3 is a block diagram illustrating a configuration of the analysis pipeline adjustment system 100 realized by a computer in the first example embodiment of the present invention.

In this case, the analysis pipeline adjustment system 100 includes a CPU 101, a storage device 102 (storage medium) such as a hard disk and a memory, an input-output device 103 such as a keyboard and a display, and a communication device 104 that communicates with another device and the like. The CPU 101 executes a program for realizing the initialization unit 110 and the adjustment unit 150. The storage device 102 stores information of the validation module storage unit 120, the search module storage unit 130, and the analysis pipeline storage unit 140. The input-output device 103 receives inputs of a validation module, a search module, and an analysis pipeline to be used from a user, and outputs an analysis pipeline model to the user. Further, the communication device 104 may receive a validation module, a search module, and an analysis pipeline to be used from another device and the like, or may transmit an analysis pipeline model to another device and the like.

Further, a part or the whole of each of the structural components of the analysis pipeline adjustment system 100 in FIG. 2 may be realized by general-purpose or dedicated circuitry, a processor, and a combination thereof. The circuitry and the processor may be formed by a single chip or a plurality of chips connected to one another via a bus. Further, a part or the whole of each of the structural components of the analysis pipeline adjustment system 100 may be realized by a combination of the above-described circuitry and the like and a program.

When a part or the whole of each of the structural components of the analysis pipeline adjustment system 100 in FIG. 2 is realized by a plurality of information processing devices, pieces of circuitry, and the like, the plurality of information processing devices, the pieces of circuitry, and the like may be arranged centralizedly or distributedly. For example, the information processing devices, the pieces of circuitry, and the like may be realized as a form in which each is connected via a communication network, such as a client-and-server system or a cloud computing system.

Next, operation of the first example embodiment of the present invention is described.

It is assumed herein that data to be analyzed is the data “data1” in FIG. 5. It is also assumed that, an analysis pipeline to be used is “Pipeline1” in FIG. 4, a validation module to be used is “SingleValidation1” that performs Single Validation, and a search module to be used is “GridSearch1” that performs Grid Search.

Furthermore, it is assumed that the validation module, the search module, and the analysis pipeline to be used are stored in advance by a user and the like in the validation module storage unit 120, the search module storage unit 130, and the analysis pipeline storage unit 140, respectively.

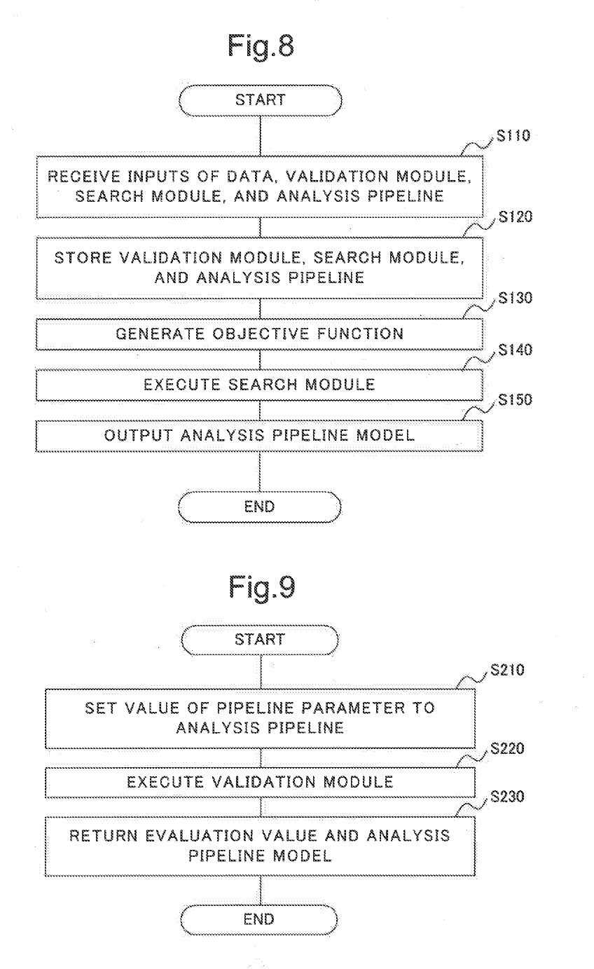

FIG. 8 is a flowchart illustrating operation of the analysis pipeline adjustment system 100 in the first example embodiment of the present invention.

First, the initialization unit 110 receives inputs of the data to be analyzed, and the validation module, the search module, and the analysis pipeline to be used from a user and the like (Step S110).

For example, the initialization unit 110 receives inputs of the data “data1” to be analyzed, and the validation module “SingleValidation1”, the search module “GridSearch1”, and the analysis pipeline “Pipeline1” to be used.

The initialization unit 110 stores the validation module, the search module, and the analysis pipeline in the validation module storage unit 120, the search module storage unit 130, and the analysis pipeline storage unit 140, respectively (Step S120). Herein, the initialization unit 110 may apply necessary configuration on the validation module and the search module.

For example, the initialization unit 110 configures the validation module “SingleValidation1” in such a way as to calculate an RMSE as an evaluation value and use 80 percent of data for learning and 20 percent of the data for testing as a division ratio of the data.

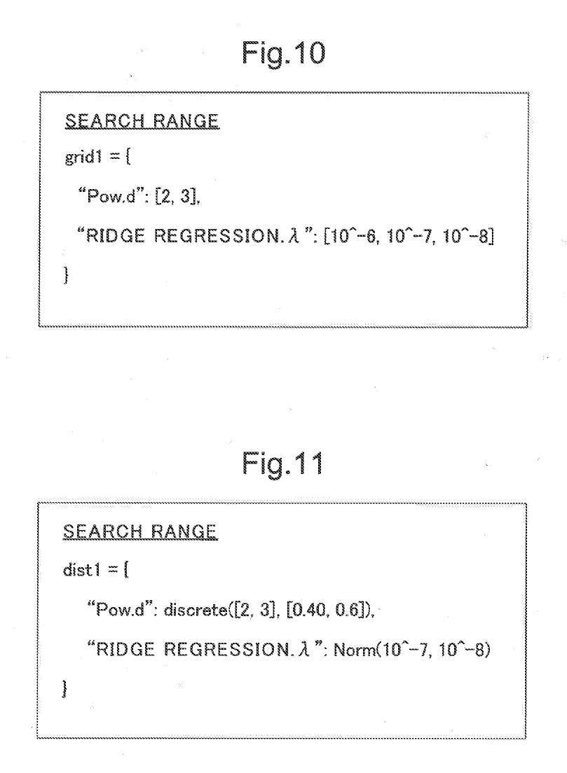

FIG. 10 is a diagram illustrating an example of a search range in the first example embodiment of the present invention. The initialization unit 110 sets, as a search range of the search module “GridSearch1”, “grid1” as in FIG. 10 in accordance with the analysis pipeline to be used “Pipeline1”, for example.

In FIG. 10, “Pow.d”:[2, 3] represents that candidates for a value of a degree d set in the block “Pow” of the analysis pipeline are 2 and 3. Further, “RIDGE REGRESSION.λ”:[10̂-6, 10̂-7, 10̂-8] represents that candidates for a value of a regularization parameter λ of the block “RIDGE REGRESSION” are 10̂-6, 10̂-7, and 10̂-8 (̂represents a power). In this case, there are six combinations of values in a search range for values of a parameter set (degree d and regularization parameter λ).

Next, the adjustment unit 150 acquires the analysis pipeline and the validation module to be used from the analysis pipeline storage unit 140 and the validation module storage unit 120, respectively. The adjustment unit 150 generates an objective function for the data to be analyzed, and the analysis pipeline and the validation module to be used (Step S130).

For example, the adjustment unit 150 generates an objective function f1(x) that performs the process as in FIG. 9 for the data “data1”, the analysis pipeline “Pipeline1”, and the validation module “SingleValidation1”.

Next, the adjustment unit 150 acquires the search module to be used from the search module storage unit 130. The adjustment unit 150 inputs the generated objective function to the search module to be used, and executes the search module (Step S140).

For example, the adjustment unit 150 inputs the objective function f1(x) to the search module “GridSearch1”, and executes the search module “GridSearch1”.

The search module “GridSearch1” executes the objective function f1(x) for each of the six combinations of the values of the parameter set (degree d and regularization parameter λ) specified in the search range “grid1”.

For example, the search module “GridSearch1” sets the values “degree d=2 and regularization parameter λ=10̂-6” of the parameter set included in the search range “grid1” to an argument x, and executes the input objective function f1(x).

The objective function f1(x) sets the values “degree d=2 and regularization parameter λ=10̂-6” of the parameter set specified as the argument x to the analysis pipeline “Pipeline1”. Then, the objective function f1(x) inputs the data “data1” and the analysis pipeline “Pipeline1” to the validation module “SingleValidation1” and executes the validation module “SingleValidation1”.

The validation module “SingleValidation1” generates the analysis pipeline model “PipelineModel1” by using the data “data1” and the analysis pipeline “Pipeline1”. Herein, the validation module “SingleValidation1” generates the analysis pipeline model “PipelineModel1” by using 80 percent of the data “data1” as data for learning. Then, the validation module “SingleValidation1” calculates an evaluation value (RMSE) by using remaining 20 percent of the data “data1” as data for testing. The validation module “SingleValidation1” returns the analysis pipeline model “PipelineModel1” and the evaluation value (RMSE).

The objective function f1(x) returns the evaluation value (RMSE) and the analysis pipeline model “PipelineModel1” obtained as a result of the execution of the validation module “SingleValidation1” as a return value.

The search module “GridSearch1” returns, to the adjustment unit 150, an analysis pipeline model for a combination for which the evaluation value (RMSE) included in the return value is minimum among the six combinations of the values of the parameter set specified in the search range “grid1”.

Next, the adjustment unit 150 outputs the analysis pipeline model returned from the search module to a user and the like (Step S150).

For example, the adjustment unit 150 outputs the analysis pipeline model “PipelineModel1” returned from the search module.

Hereinafter, a user and the like may perform a prediction or an analysis on new data by using the generated analysis pipeline model “PipelineModel1”.

As described above, the operation of the first example embodiment of the present invention is completed.

Note that, a case where the validation module that performs Single Validation and the search module that performs Grid Search are respectively used as a validation module and a search module is described as an example herein. However, the present invention is not limited to this, and another validation module and another search module may be used as long as inputs, outputs, and a process of the validation module and the search module follow the above-described definitions.

For example, “CrossValidation1” that performs Cross Validation and “RandomSearch1” that performs Random Search may be respectively used as a validation module and a search module.

In this case, for example, the validation module “CrossValidation1” divides the data “data1” into 10 data blocks, performs cross-validation for the 10 data blocks, and returns an average of evaluation values (RMSEs) and the analysis pipeline model “PipelineModel1” for which an evaluation value (RMSE) is minimum.

FIG. 11 is a diagram illustrating another example of a search range in the first example embodiment of the present invention. The initialization unit 110 sets, a search range “dist1” as in FIG. 11 to the search module “RandomSearch1”, for example. In FIG. 11, “Pow.d”: discrete ([2, 3], [0.40, 0.6]) represents a multinomial distribution in which “2” appears with a probability of 40% and “3” appears with a probability of 60%, and Norm(10̂-7, 10̂-8) represents a normal distribution with an average 10̂-7 and a standard deviation 10̂-8. The search module “RandomSearch1” samples a predetermined number (for example, 100) of combinations of values of a parameter set according to a distribution indicated by the search range “dist1”, and executes the objective function f1(x) for each of the combinations. Then, the search module “RandomSearch1” returns, to the adjustment unit 150, the analysis pipeline model “PipelineModel1” for a combination for which the evaluation value (RMSE) included in the return value is minimum among the predetermined number of combinations of the values of the parameter set.

Further, it is described as an example herein that the parameter set includes a parameter (pipeline parameter) related to a pre-process and a learning process in an analysis pipeline. However, the present invention is not limited to this, and the parameter set may include a parameter related to validation process in a validation module.

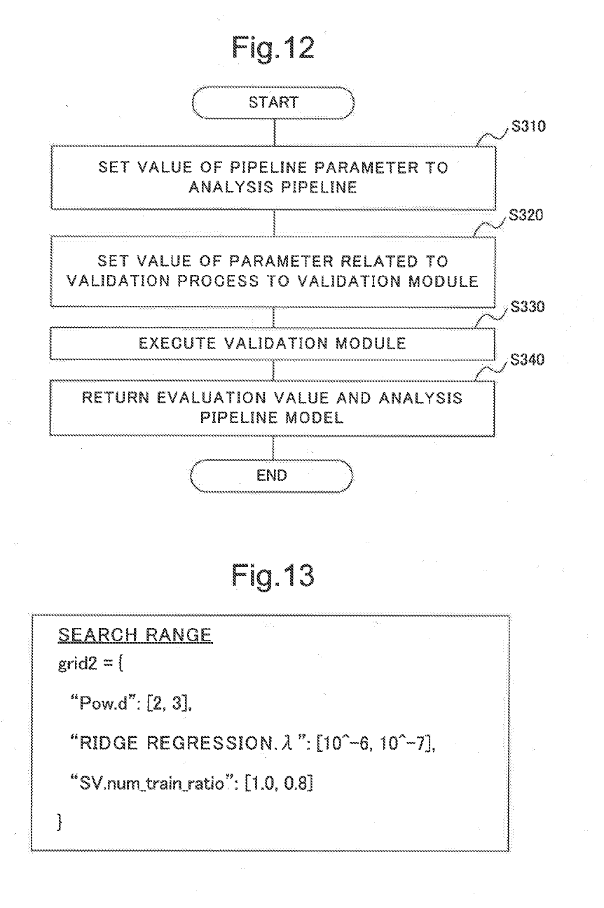

FIG. 12 is a flowchart illustrating another process of an objective function in the first example embodiment of the present invention. In this case, the objective function sets (applies) a value of a pipeline parameter included in a combination of values of a parameter set specified as an argument x to an analysis pipeline (Step S310). The objective function sets (applies) a value of a parameter related to a validation process included in the combination of the values of the parameter set to a validation module to be used (Step S320). The objective function inputs data to be analyzed and the analysis pipeline to which the value of the pipeline parameter is set (applied) to the validation module to be used, and executes the validation module (Step S330). The objective function returns (outputs) an evaluation value and an analysis pipeline model obtained as a result of the execution of the validation module as a return value to the search module (Step S340).

Note that, the objective function may input a combination of values of a parameter set as a list of “key” and “value” to the validation module, for example. In this case, when there is “key” of a parameter that can be set (applied) to the validation module in the list, the validation module sets (applies) a value of “value” associated with “key”. In this way, even when the validation module is different, behavior of the validation process can be changed with the same interface.

As a value of a parameter related to the validation process, a parameter value for specifying a narrowing ratio of data for learning is used, for example.

FIG. 13 is a diagram illustrating another example of a search range in the first example embodiment of the present invention. For example, it is assumed that the initialization unit 110 sets a search range “grid2” as in FIG. 13 to a search module “GridSearch2” that performs Grid Search.

In FIG. 13, “SV.num_train_ratio”:[1.0, 0.8] represents that candidates for a value of a narrowing ratio of data for learning num_train_ratio, which is set (applied) to the validation module that performs SingleValidation, are 1.0 and 0.8. The validation module performs learning by using all data for learning, when the narrowing ratio num_train_ratio is 1.0. Further, the validation module selects 80 percent of data for learning (narrows data for learning to 80 percent) and performs learning, when the narrowing ratio num_train_ratio is 0.8. For example, when data are divided into data for learning and data for testing in time series, 80 percent of the data for learning closer to the data for testing is selected.

In this case, there are eight combinations of values in a search range of values for a parameter set (degree d, regularization parameter λ, and narrowing ratio num_train_ratio).

The adjustment unit 150 generates an objective function f2(x) that performs the process as in FIG. 12 for the data “data1”, the analysis pipeline “Pipeline1”, and the validation module “SingleValidation1”.

The search module “GridSearch2” executes the validation module “SingleValidation1” through the objective function f2(x) for each of the eight combinations of the values of the parameter set specified in the search range “grid2”, and obtains an analysis pipeline model.

Further, as a parameter value related to the validation process, a value of a parameter (Refit flag) that specifies relearning (Refit process) with all pieces of data may be used.

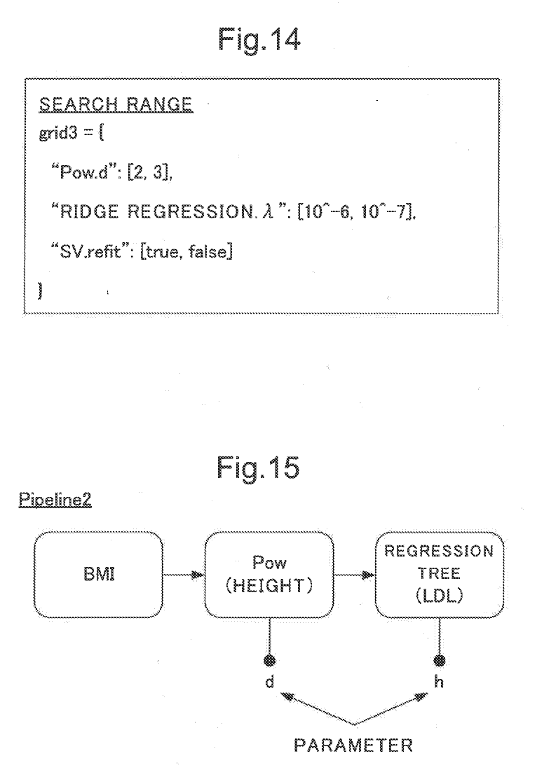

FIG. 14 is a diagram illustrating another example of a search range in the first example embodiment of the present invention. It is assumed that the initialization unit 110 sets a search range “grid3” as in FIG. 14 to a search module “GridSearch3” that performs Grid Search.

In FIG. 14, “SV.refit”:[true, false] represents candidates for a value of a Refit flag “refit” set (applied) to the validation module that performs SingleValidation include true and false. When the Refit flag is false, the validation module performs learning using data for learning and calculates an evaluation value using data for testing, and returns an obtained analysis pipeline model. On the other hand, when the Refit flag is true, the validation module performs learning using data for learning and calculates an evaluation value using data for testing, and then updates an analysis pipeline model by relearning using all pieces of data (data for learning and data for testing). The validation module returns the analysis pipeline model updated by relearning.

In this case, there are eight combinations of values in a search range for values of a parameter set (degree d, regularization parameter λ, and Refit flag).

The search module “GridSearch3” executes the validation module “SingleValidation1” through the objective function f2(x) for each of the eight combinations of the values of the parameter set specified in the search range “grid3”, and obtains an analysis pipeline model.

In this way, a parameter set including a condition related to learning data and a condition related to relearning can be adjusted by including a parameter related to the validation process of the validation module into the parameter set, and thus an analysis pipeline model with a higher degree of precision can be obtained.

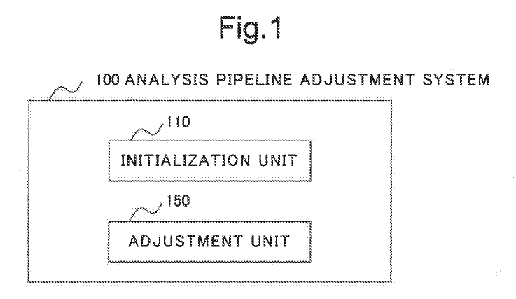

Next, a characteristic configuration of the first example embodiment of the present invention is described. FIG. 1 is a block diagram illustrating a characteristic configuration of the first example embodiment of the present invention. The analysis pipeline adjustment system 100 (information processing system) includes the initialization unit 110 and the adjustment unit 150.

The initialization unit 110 receives an input of a validation module that generates an analysis pipeline model and calculates an evaluation value by using an input analysis pipeline in accordance with a predetermined validation method, and outputs the analysis pipeline model and the evaluation value.

The adjustment unit 150 searches for, within a search range of a parameter set and in accordance with a predetermined search method, a value of the parameter set for which the evaluation value is optimized by executing the validation module inputting to the validation module the analysis pipeline to which a value of the pipeline parameter is applied. The adjustment unit 150 outputs the analysis pipeline model for which the evaluation value is optimized.

Next, an advantageous effect of the first example embodiment of the present invention is described.

According to the first example embodiment of the present invention, a parameter related to an analysis pipeline can be adjusted for various validation methods. The reason is described as follows. That is, the initialization unit 110 receives an input of a validation module that generates an analysis pipeline model and calculates an evaluation value by using an input analysis pipeline in accordance with a predetermined validation method, and outputs the analysis pipeline model and the evaluation value. Then, the adjustment unit 150 searches for, within a search range of a parameter set and in accordance with a predetermined search method, a value of the parameter set for which the evaluation value is optimized by executing the validation module inputting to the validation module the analysis pipeline to which a value of the pipeline parameter is applied.

Further, according to the first example embodiment of the present invention, a parameter related to an analysis pipeline can be adjusted for various combinations of a validation method and a search method. The reason is described as follows. That is, the initialization unit 110 receives an input of a search module that searches for, within a search range of a parameter set and in accordance with a predetermined search method, a value of a parameter set for which an evaluation value is optimized by executing an objective function inputting a value of the parameter set to the objective function. Herein, the objective function is a function that outputs an analysis pipeline model and an evaluation value obtained by executing the validation module inputting to the validation module an analysis pipeline to which a value of a pipeline parameter included in an input parameter set is applied. Then, the adjustment unit 150 generates the objective function and executes the search module.

### Second Example Embodiment

Next, a second example embodiment of the present invention is described.

The second example embodiment of the present invention is different from the first example embodiment of the present invention in that an analysis pipeline to be used is also specified as a parameter.

First, a configuration of the second example embodiment of the present invention is described.

A block diagram illustrating a configuration of an analysis pipeline adjustment system 100 in the second example embodiment of the present invention is similar to that (FIG. 2) of the first example embodiment of the present invention.

In the second example embodiment of the present invention, an analysis pipeline storage unit 140 stores a plurality of analysis pipelines. Further, a parameter set includes an identifier of an analysis pipeline to be used in the second example embodiment of the present invention.

FIG. 17 is a flowchart illustrating a process of an objective function in the second example embodiment of the present invention. The objective function acquires an analysis pipeline of an identifier included in a parameter set specified as an argument x, from the analysis pipeline storage unit 140 (Step S510). The objective function sets (applies) a value of a pipeline parameter included in the parameter set to the acquired analysis pipeline (Step S520). The objective function inputs data to be analyzed and the analysis pipeline to which the value of the pipeline parameter is set (applied) to a validation module to be used, and executes the validation module (Step S530). The objective function returns (outputs) an evaluation value and an analysis pipeline model obtained as a result of the execution of the validation module as a return value to a search module (Step S540).

Note that, the objective function may generate an analysis pipeline of an identifier included in a parameter set, based on information related to the analysis pipeline, instead that the analysis pipeline storage unit 140 stores a plurality of analysis pipelines.

Next, operation of the second example embodiment of the present invention is described.

FIG. 15 is a diagram illustrating an example of an analysis pipeline in the second example embodiment of the present invention. An analysis pipeline “Pipeline2” in FIG. 15 is an analysis pipeline that generates an analysis pipeline model that predicts low density lipoprotein (LDL) cholesterol from human height and weight, similarly to the analysis pipeline “Pipeline1” in FIG. 4. Herein, in the analysis pipeline “Pipeline2”, as blocks for performing pre-process on data, a block “BMI” for calculating a BMI and a block “Pow (HEIGHT)” for calculating a d-th power of height are set. Further, as a block for performing learning process, a block “DECISION TREE (LDL)” for generating a decision tree model that determines LDL cholesterol from the pre-processed data by using a height h of a tree is set.

It is assumed herein that data to be analyzed is the data “data1” in FIG. 5. It is also assumed that an analysis pipeline is “Pipeline1” in FIG. 4 or “Pipeline2” in FIG. 15, a validation module is “SingleValidation1” that performs Single Validation, and a search module is “GridSearch4” that performs Grid Search. It is also assumed that the analysis pipelines “Pipeline1” and “Pipeline2” to be used are specified in advance by a user and the like, for example.

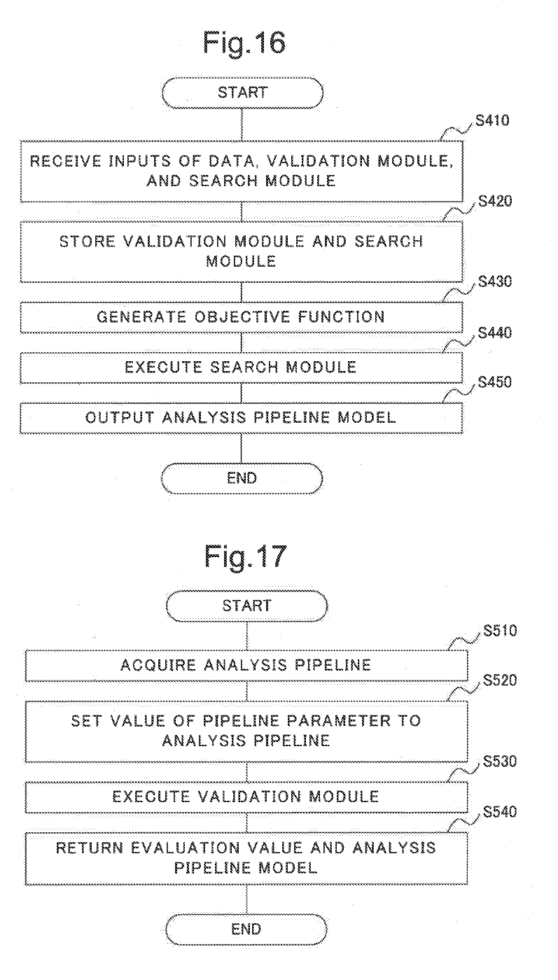

FIG. 16 is a flowchart illustrating operation of the analysis pipeline adjustment system 100 in the second example embodiment of the present invention.

First, an initialization unit 110 receives inputs of data to be analyzed, and a validation module and a search module to be used, from a user and the like (Step S410).

For example, the initialization unit 110 receives inputs of the data “data1” to be analyzed, and the validation module “SingleValidation1” and the search module “GridSearch4” to be used.

The initialization unit 110 stores the validation module and the search module in a validation module storage unit 120 and a search module storage unit 130, respectively (Step S420). Herein, the initialization unit 110 may apply necessary configuration on the validation module and the search module.

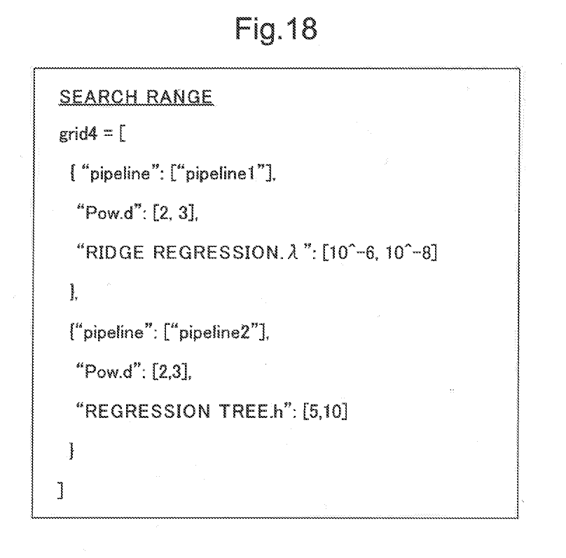

FIG. 18 is a diagram illustrating an example of a search range in the second example embodiment of the present invention. The initialization unit 110 sets, as a search range of the search module “GridSearch4”, “grid4” as in FIG. 18 in accordance with the analysis pipelines to be used “Pipeline1” and “Pipeline2”, for example.

In FIG. 18, “pipeline”:[“Pipeline1”] and “pipeline”:[“Pipeline2”] represent an identifier of the analysis pipeline in FIG. 4 and an identifier of the analysis pipeline in FIG. 15, respectively. Note that, a file path in which the analysis pipeline is stored may be set instead of an identifier of the analysis pipeline.

In this case, there are four combinations of values as a search range for values of a parameter set (degree d and regularization parameter k), for the analysis pipeline “Pipeline1”. Further, there are four combinations of values as a search range for values of a parameter set (degree d and height h of decision tree), for the analysis pipeline “Pipeline2”. In other words, there are eight combinations as a search range for values of a parameter set.

Next, an adjustment unit 150 acquires a validation module to be used from the validation module storage unit 120. The adjustment unit 150 generates an objective function for the data to be analyzed, and the validation module to be used (Step S430).

For example, the adjustment unit 150 generates an objective function f3(x) that performs the process as in FIG. 17 for the data “data1” and the validation module “SingleValidation1”.

Next, the adjustment unit 150 acquires the search module to be used from the search module storage unit 130. The adjustment unit 150 inputs the generated objective function to the search module to be used, and executes the search module (Step S440).

For example, the adjustment unit 150 inputs the objective function f3(x) to the search module “GridSearch4”, and executes the search module “GridSearch4”.

The search module “GridSearch4” executes the objective function f3(x) for each of the eight combinations of the values of the parameter set specified in the search range “grid4”.

For example, the search module “GridSearch4” sets values “analysis pipeline=“pipline2”, degree d=3, and height of decision tree h=10″ of a parameter set included in the search range “grid4” to an argument x, and executes the input objective function f3(x).

The objective function f3(x) acquires the analysis pipeline “pipline2” specified as the argument x and sets the values “degree d=3 and height of decision tree h=10” of the parameter set to the analysis pipeline “pipline2”. Then, the objective function f3(x) inputs the data “data1” and the analysis pipeline “pipline2” to the validation module “SingleValidation1” and executes the validation module “SingleValidation1”.

The validation module “SingleValidation1” generates the analysis pipeline model by using the data “data1” and the analysis pipeline “Pipeline2”.

The objective function f3(x) returns the evaluation value (RMSE) and the analysis pipeline model obtained as a result of the execution of the validation module “SingleValidation2” as a return value.

The search module “GridSearch4” returns, to the adjustment unit 150, an analysis pipeline model for a combination for which the evaluation value (RMSE) included in the return value is minimum among the eight combinations of the values of the parameter set specified in the search range “grid4”.

Next, the adjustment unit 150 outputs the analysis pipeline model returned from the search module to a user and the like (Step S450).

As described above, the operation in the second example embodiment of the present invention is completed.

Note that, a parameter set may also include a parameter related to validation process, such as a narrowing ratio of data for learning and a flag indicating relearning by all data, in the second example embodiment of the present invention, similarly to the first example embodiment of the present invention.

Next, an advantageous effect of the second example embodiment of the present invention is described.

According to the second example embodiment of the present invention, an analysis pipeline with a higher degree of precision than that in the first example embodiment of the present invention can be obtained. The reason is that a parameter set further includes an identifier of an analysis pipeline. In this way, a parameter set including a condition related to an analysis pipeline can be adjusted, and an analysis pipeline model with a higher degree of precision can be obtained.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

### REFERENCE SIGNS LIST

100 Analysis pipeline adjustment system
101 CPU
102 Storage device
103 Input-output device
104 Communication device
110 Initialization unit
120 Validation module storage unit
130 Search module storage unit
140 Analysis pipeline storage unit
150 Adjustment unit

What is claimed is:

1. An information processing system for generating an analysis pipeline model by using an analysis pipeline, the analysis pipeline including a pre-process and a learning process for data to be analyzed, a value of a pipeline parameter being a parameter related to at least one of the pre-process and the learning process being applied to the analysis pipeline, the analysis pipeline model including the pre-process and a learned model being learned with the learning process, the information processing system comprising:
a memory storing instructions; and
one or more processors configured to execute the instructions to:
receive an input of a validation module that generates the analysis pipeline model and calculates an evaluation value of the generated analysis pipeline model by using an input analysis pipeline in accordance with a predetermined validation method for the validation module, and outputs the generated analysis pipeline model and the calculated evaluation value;
generate a function that executes the input validation module inputting the analysis pipeline to which a value of the pipeline parameter included in an input parameter set is applied, and outputs the analysis pipeline model and the evaluation value obtained by executing the input validation module;
execute a search module inputting the generated function to the search module that executes the input generated function, searches for a value of the parameter set for which the evaluation value obtained by executing the input generated function is optimized within a search range of the parameter set and in accordance with a predetermined search method for the search module, and outputs the analysis pipeline model for which the evaluation value is optimized; and
output the analysis pipeline model obtained by executing the search module.

2. The information processing system according to claim 1, wherein
the one or more processors is further configured to execute the instructions to:
receive an input of the search module; and
execute the input search module inputting the generated function to the search module.

3. The information processing system according to claim 1, wherein the parameter set further includes an identifier of the analysis pipeline, and, when the validation module is executed, the analysis pipeline indicated by an identifier of the analysis pipeline to which a value of the pipeline parameter included in the parameter set is applied is input.

4. The information processing system according to claim 1, wherein
the parameter set further includes a parameter related to the predetermined validation method,
the validation module generates the analysis pipeline model and calculates the evaluation value of the analysis pipeline model in accordance with the predetermined validation method associated with an input value of the parameter related to the predetermined validation method, and,
when the validation module is executed, the value of the parameter related to the predetermined validation method is input in addition to the analysis pipeline to which the value of the pipeline parameter included in the parameter set is applied.

5. The information processing system according to claim 4, wherein
the parameter related to the predetermined validation method is a parameter for specifying a narrowing ratio of data for learning, and
the validation module, when dividing the data to be analyzed into data for learning for generating the analysis pipeline model and data for testing for calculating the evaluation value of the analysis pipeline model, further narrows the data for learning obtained by dividing in accordance with a value of the parameter for specifying a narrowing ratio of data for learning.

6. The information processing system according to claim 4, wherein
the parameter related to the predetermined validation method is a parameter for specifying relearning, and
the validation module generates the analysis pipeline model by the learning process using data for learning among the data to be analyzed, calculates the evaluation value of the analysis pipeline model by using data for testing among the data to be analyzed, and then updates the analysis pipeline model by further performing the learning process using the data for learning and the data for testing in accordance with a value of the parameter for specifying the relearning.

7. An information processing method for generating an analysis pipeline model by using an analysis pipeline, the analysis pipeline including a pre-process and a learning process for data to be analyzed, a value of a pipeline parameter being a parameter related to at least one of the pre-process and the learning process being applied to the analysis pipeline, the analysis pipeline model including the pre-process and a learned model being learned with the learning process, the information processing method comprising:
receiving an input of a validation module that generates the analysis pipeline model and calculates an evaluation value of the generated analysis pipeline model by using an input analysis pipeline in accordance with a predetermined validation method for the validation module, and outputs the generated analysis pipeline model and the calculated evaluation value;
generating a function that executes the input validation module inputting the analysis pipeline to which a value of the pipeline parameter included in an input parameter set is applied, and outputs the analysis pipeline model and the evaluation value obtained by executing the input validation module;
executing a search module inputting the generated function to the search module that executes the input generated function, searches for a value of the parameter set for which the evaluation value obtained by executing the input generated function is optimized within a search range of the parameter set and in accordance with a predetermined search method for the search module, and outputs the analysis pipeline model for which the evaluation value is optimized; and
outputting the analysis pipeline model obtained by executing the search module.

8. The information processing method according to claim 7, further comprises:
receiving an input of the search module; and
executing the input search module inputting the generated function to the search module.

9. A non-transitory computer readable storage medium recording thereon a program for generating an analysis pipeline model by using an analysis pipeline, the analysis pipeline including a pre-process and a learning process for data to be analyzed, a value of a pipeline parameter being a parameter related to at least one of the pre-process and the learning process being applied to the analysis pipeline, the analysis pipeline model including the pre-process and a learned model being learned with the learning process, the program causing a computer to perform processes comprising:
receiving an input of a validation module that generates the analysis pipeline model and calculates an evaluation value of the generated analysis pipeline model by using an input analysis pipeline in accordance with a predetermined validation method for the validation module, and outputs the generated analysis pipeline model and the calculated evaluation value;
generating a function that executes the input validation module inputting the analysis pipeline to which a value of the pipeline parameter included in an input parameter set is applied, and outputs the analysis pipeline model and the evaluation value obtained by executing the input validation module;
executing a search module inputting the generated function to the search module that executes the input generated function, searches for a value of the parameter set for which the evaluation value obtained by executing the input generated function is optimized within a search range of the parameter set and in accordance with a predetermined search method for the search module, and outputs the analysis pipeline model for which the evaluation value is optimized; and
outputting the analysis pipeline model obtained by executing the search module.

10. The computer readable storage medium recording thereon the program according to claim 9, the processes further comprises:
receiving an input of the search module; and
executing the input search module inputting the generated function to the search module.
